(19) United States
(12) Patent Application Publication
(10) Pub. No.: US 2014/0009253 A1
(43) Pub. Date: Jan. 9, 2014

(54) CURRENT TRANSFORMER

(71) Applicants: Jonathan C. Dell, Carpentersville, IL (US); Henry R. Vanderzyden, Byron, IL (US); Jeffrey D. Baldwin, Rockford, IL (US); Kevin K. Wege, Beloit, WI (US)

(72) Inventors: Jonathan C. Dell, Carpentersville, IL (US); Henry R. Vanderzyden, Byron, IL (US); Jeffrey D. Baldwin, Rockford, IL (US); Kevin K. Wege, Beloit, WI (US)

(21) Appl. No.: 13/542,698

(22) Filed: Jul. 6, 2012

(51) Int. Cl. H01F 38/30

(52) U.S. Cl. 336/174

(57) ABSTRACT

An improved current transformer has a ring shaped core and a plurality of windings wound around the ring shaped core. The ring shaped core has a rectangular cross sectional area configured to provide a current transformer current rating of at least 375 amperes.

### TECHNICAL FIELD

The present disclosure relates generally to generator modules for aircraft, and more particularly to fault detection current transformers for use in the same.

### BACKGROUND OF THE INVENTION

Generator modules, and particularly aircraft generator modules, are subject to internal and external short circuits (faults) that affect the operation of the generator module. In order to detect short circuits internal or external to the generator module, an internal current transformer is used to determine an internal current of the generator module. An external current transformer is simultaneously used to determine a current exiting the generator module. When the current measurements of the external current transformer and the internal current transformer differ by more than a predefined threshold, a controller determines that a fault exists internal or external to the generator module, and appropriate action is taken by the controller. The internal current transformer is physically located on the neutral side of the generator phase windings to include the generator windings in the protected zone.

Current transformers have a saturation point at which the secondary output of the current transformer no longer increases linearly despite a continued increase in the primary current passing through the current transformer. When saturation of the internal current transformer occurs, the difference between the internal current transformer measurement and the external current transformer measurement during a short circuit can exceed the threshold, resulting in the controller failing to detect the fault when a fault exists, or, falsely sensing a fault when no fault exists.

### SUMMARY OF THE INVENTION

Disclosed is a current transformer having a ring shaped magnetic core defining an axis, a plurality of windings wound around the core, a ring shaped housing encompassing the core and the windings, and a pair of output leads connected to the windings. The ring shaped magnetic core has a rectangular cross sectional area defining a range of axial heights and a range of radial widths operable to provide a suitable current transformer current rating.

Also disclosed is a generator module for an aircraft having a generator, an internal current transformer operable to detect an internal current of the generator module, and operable to output the detected internal current to a controller. The current transformer has a ring shaped magnetic core defining an axis, a plurality of windings wound around the core, a ring shaped housing encompassing the core and the windings, and a pair of output leads connected to the windings. The ring shaped magnetic core has a rectangular cross sectional area defining a range of axial heights and a range of radial widths operable to provide a suitable current transformer current rating.

Also disclosed is a method of assembling a generator module having the steps of: determining a maximum short circuit current through a generator module, installing an internal current transformer in the generator module, wherein the current transformer has a core cross sectional area sufficient to accommodate a primary current rating of the internal current transformer in excess of the maximum short circuit current through the generator module, and connecting the internal current transformer to a controller, wherein the controller is further connected to a corresponding external current transformer, such that the controller can compare an internal current of the generator module and an output current of the generator module and determine when a fault is present in the system.

These and other features of the present invention can be best understood from the following specification and drawings, the following of which is a brief description.

### BRIEF DESCRIPTION OF THE DRAWINGS

FIG. 1 schematically illustrates a generator module.

FIG. 2 illustrates an isometric view of a current transformer.

FIG. 3 illustrates a cross sectional view of the current transformer of FIG. 1.

FIG. 4 illustrates a top view of the current transformer of FIG. 1.

### DETAILED DESCRIPTION

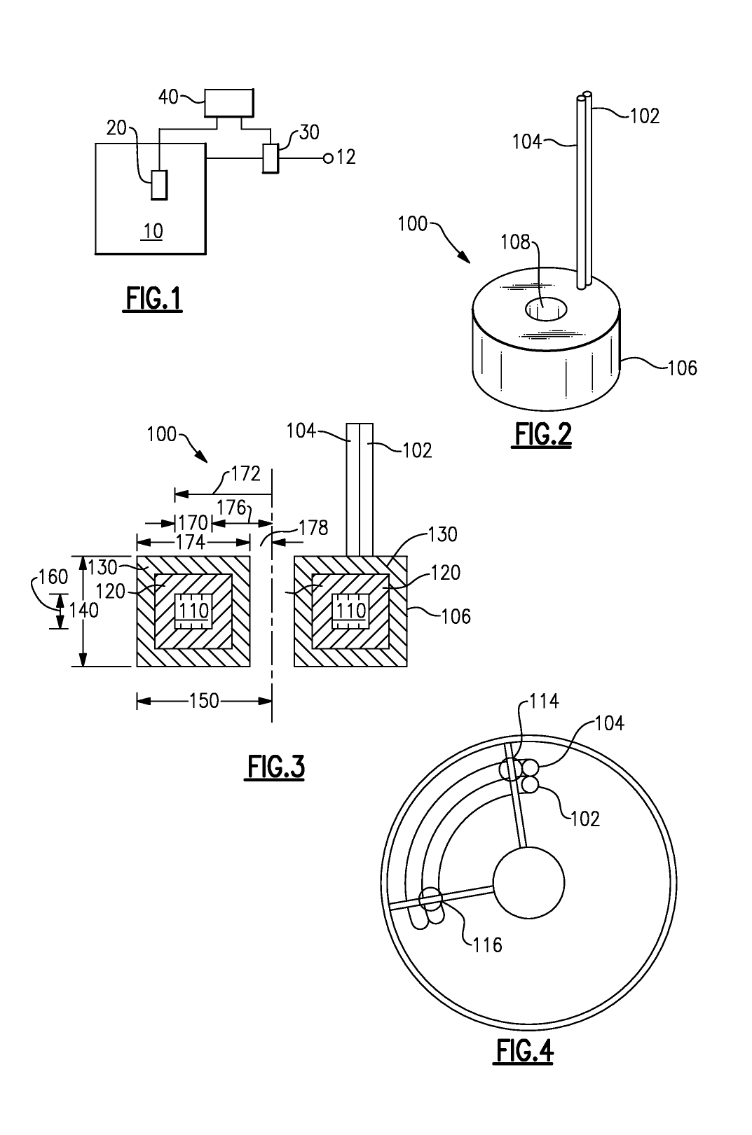

FIG. 1 schematically illustrates a generator module 10 that outputs an electric current at an output 12. Within the generator module 10 is an internal current transformer 20 that measures an internal current of the generator module 10. The internal current transformer 20 is physically located on the neutral side of the generator phase windings to include the generator windings in the protected zone.

Connected to the generator module 10, and measuring an output current of the generator module 10, is an external current transformer 30. Both the internal current transformer 20 and the external current transformer 30 are connected to a controller 40. The controller 40 reads the detected currents from each of the internal current transformer 20 and the external current transformer 30, and identifies an internal or external fault when the detected currents vary by an amount greater than a predetermined threshold. Both the internal current transformer 20 and the external current transformer 30 have an identical primary to secondary current ratio. By appropriate sectioning of the secondary turns in the windings of each of the current transformers 20, 30, a designer can ensure that the current transformers 20, 30 have the same ratio of input primary current to output secondary current, and thereby ensure that an accurate comparison is performed.

Current transformers, such as internal current transformer 20, have a saturation threshold. The saturation threshold of the current transformer depends on the amount of core material in the current transformer core, as well as other factors. When primary current passing through the current transformer exceeds the saturation threshold, the secondary output of the current transformer (the current measurement) peaks and stops increasing in a linear fashion. This affect causes a saturated current transformer to be unable to give an accurate current reading above the current saturation threshold, and necessarily impacts the fault detection of the controller 40. One of skill in the art, in light of this disclosure, would understand that increasing the amount of the core material, with consideration for the differences in properties between the cores of the internal and external current transformers or the number of turns in the winding, increases the current saturation threshold of the current transformer without impacting the ratio of input current to output current.

FIGS. 2, 3, and 4 illustrate an improved current transformer 100 for use as the internal current transformer 20 within a generator module 10. Turning first to FIG. 2, FIG. 2 illustrates an isometric view of the improved current transformer 100. The current transformer 100 includes a pair of leads 102, 104 that provide a secondary output corresponding to a primary current. In the example of FIG. 1, the leads 102, 104 are connected to the controller 40 and provide the controller 40 with the internal current readings of the generator module 10. The current transformer 100 also includes a ring shaped body 106 having an opening 108. The current transformer 100 measures the primary current in a conductor that is passed through the opening 108. The ring shaped body 106 includes a magnetic core section, a secondary winding wrapped around the core and a housing encapsulating the core and the current transformer windings.

FIG. 3 illustrates the internal components of the current transformer 100 via a cross sectional view of the current transformer 100. The current transformer 100 includes a magnetic core 110, multiple windings 120, and a housing 130 encasing the core 110 and the windings 120. The secondary windings 120 are wound around the core 110 and provide the current sensing.

In the particular example illustrated in FIG. 3, the current transformer body 106 has an axial height 140 of 0.520 inches relative to an axis defined by the ring shaped body 106. It is understood, however, that current transformer bodies 106 could similarly have a shorter axial height 140. The core 110 has a rectangular cross section with a cross sectional area of 0.0235 square inches and facilitates a primary current rating of at least 375 amperes. The cross sectional area of 0.0235 inches defines a range of axial heights 160 and radial widths 170 able to generate the cross sectional area. In one specific example, the core 110 has an axial height 160 of 0.188 inches, and the core 110 has an inner radius 176 of 0.250 inches and an outer radius 172 of 0.375 inches, resulting in a radial width 170 of 0.125 inches.

In order to fit properly within the packaging of a generator module 10, the current transformer 100 has a maximum axial height 140 and a maximum outer radius 150 that the ring shaped body 106 should not exceed. In a specific example, the ring shaped body 106 has an outer radius 150 of 0.475 inches and an inner radius 178 of 0.115 inches, resulting in a radial width 174 of 0.360 inches. In the specific example, the housing 130 has a cross sectional area of 0.187 square inches.

When determining the type and construction of the improved current transformer 100, it is recognized that varying magnetic core materials and varying numbers of secondary turns within the windings will affect an input current to output current ratio. As such, it is desirable to match the number of winding 120 turns in the improved current transformer 100 to the composition of the core and the number of winding turns in the external current transformer 30 (illustrated in FIG. 1). It is further desirable to account for the difference in properties between the magnetic core materials of the internal current transformer and the external current transformer. In the specific example, the current transformer winding 120 of the internal current transformer 20, 100 has five hundred turns. In one example, the current transformer core 110 is constructed primarily of an alloy such as iron-cobalt.

FIG. 4 illustrates a top view of the current transformer 100 with a cut away section revealing the connection of the leads 102, 104 to the windings 120. Each of the leads 102, 104 is connected to at least two complete turns of a lacing tape. The leads are connected at connection points 114, 116. The connection points 114, 116 are separated by at least 90 degrees, around the ring shaped body 106 of the current transformer 100.

Although an embodiment of this invention has been disclosed, a worker of ordinary skill in this art would recognize that certain modifications would come within the scope of this invention. For that reason, the following claims should be studied to determine the true scope and content of this invention.

1. A current transformer (CT) comprising:
a ring shaped magnetic core defining an axis;
a plurality of windings wound around said core;
a ring shaped housing encompassing said core and said windings;
a pair of output leads connected to said windings;
wherein said ring shaped core has a rectangular cross sectional area defining a range of axial heights and a range of radial widths operable to provide a current transformer current rating of at least 375 amperes.

2. The current transformer of claim 1, wherein said range of axial heights and said range of radial widths define a cross sectional area of 0.0235 square inches.

3. The current transformer of claim 2, wherein said axial height is 0.188 inches and said radial width 0.125 inches.

4. The current transformer of claim 1, wherein said ring shaped housing has an axial height less than or equal to 0.520 inches.

5. The current transformer of claim 1, wherein said ring shaped core comprises an inner opening, and wherein a ratio of said inner opening radius to an outer radius of said ring shaped core is 0.25 to 0.375.

6. The current transformer of claim 1, wherein a ratio of said core cross sectional area to a housing cross sectional area is 0.0235 to 0.187.

7. The current transformer of claim 1, wherein said plurality of turns consists of 500 turns.

8. The current transformer of claim 1, wherein each of said pair of leads is connected to said plurality of windings via at least two full turns of a lacing tape.

9. The current transformer of claim 8, wherein a first lead in said pair of leads is connected at a first location, and a second lead in said pair of leads is connected at a second location, and wherein each of said first and second location are separated by at least 90 degrees.

10. The current transformer of claim 1, wherein said core is constructed of a core material comprising an alloy including iron-cobalt.

11. The current transformer of claim 10, wherein said core material consists of an iron-cobalt alloy.

12. A generator module for an aircraft comprising;
a generator;
an internal current transformer operable to detect an internal current of the generator module and operable to output the detected internal current to a controller;
wherein the internal current transformer has a ring shaped core defining an axis, a plurality of windings wound around said core, a ring shaped housing encompassing said core and said windings, a pair of output leads connected to said windings, and wherein said ring shaped core has a rectangular cross sectional area defining a range of axial heights and a range of radial widths operable to provide a current transformer current rating of at least 375 amperes.

13. The current transformer of claim 1, wherein said range of axial heights and a range of radial widths define a cross sectional area of 0.0235 square inches.

14. The current transformer of claim 13, wherein said axial height is 0.188 inches and said radial width 0.125 inches.

15. The current transformer of claim 1, wherein said ring shaped housing has an axial height no larger than 0.520 inches.

16. The current transformer of claim 1, wherein said ring shaped core comprises an inner opening, and wherein a ratio of said inner opening radius to an outer radius of said ring shaped core is 0.25 to 0.375.

17. The current transformer of claim 1, wherein a ratio of said core cross sectional area to a housing cross sectional area is 0.0235 to 0.187.

18. The current transformer of claim 1, wherein said plurality of turns consist of 500 turns.

19. The current transformer of claim 1, wherein each of said pair of leads is connected to said plurality of windings via at least two full turns of a lacing tape.

20. The current transformer of claim 19, wherein a first lead in said pair of leads is connected at a first location, and a second lead in said pair of leads is connected at a second location, and wherein each of said first and second location are separated by at least 90 degrees.

21. The current transformer of claim 1, wherein said core is constructed of a core material comprising an alloy including iron-cobalt.

22. The current transformer of claim 21, wherein said core material consists of an iron-cobalt alloy.

23. A method of assembling a generator module comprising the steps of:
determining a maximum short circuit current through a generator module;
installing an internal current transformer in said generator module, wherein said current transformer has a core cross sectional area operable to allow a current rating of the internal current transformer to exceed the maximum short circuit current through the generator module; and
connecting the internal current transformer to a controller, wherein the controller is further connected to a corresponding external current transformer, such that the controller can compare an internal current of the generator module and an output current of the generator module and determine when a fault is present in the generator module.

24. The method of claim 23, further comprising the step of:
matching said internal current transformer to the external current transformer, such that both the internal current transformer and the external current transformer share a common current ratio and a core material, thereby ensuring that said internal current transformer and said external current transformer have the same input current to output current ratio.

25. The method of claim 23, further comprising ensuring that each of said internal current transformer and said external current transformer have a core with a rectangular cross sectional area, the rectangular cross sectional area having an axial height to radial width ratio that defines a cross sectional area of 0.0235 square inches.
